(19) United States
(12) Patent Application Publication
(10) Pub. No.: US 2024/0038079 A1
(43) Pub. Date: Feb. 1, 2024

(54) Drone Dispatch System

(71) Applicant: Nicholas Feldewerd, Minneapolis, MN (US)

(72) Inventor: Nicholas Feldewerd, Minneapolis, MN (US)

(21) Appl. No.: 17/875,825

(22) Filed: Jul. 28, 2022

(51) Int. Cl. G08G 5/00; G08G 5/04; B64C 39/02

(52) U.S. Cl. CPC G08G 5/0069; G08G 5/006; G08G 5/0013; G08G 5/0043; G08G 5/045; B64C 39/024; B64C 2201/145; B64C 2201/146

(57) ABSTRACT

A drone dispatch system that provides individuals and/or organizations instant access to one or more drones at any remote location without requiring physical proximity. Some embodiments may include a computer implemented application that provides access to a drone storage and recharge location called a “Sky Hub”. In some embodiments, a network of drones may be interconnected and in communication among themselves in order to avoid in flight collisions. Some embodiments may utilize a computer implemented application that provides access to a drone storage and recharge location called a “Sky Hub”. In some embodiments, a network of drones may be interconnected and in communication among themselves in order to avoid in flight collisions.

### BACKGROUND

The present disclosure relates generally to an a system for coordinating the actions of unmanned aircraft.

The rise in the use of autonomous unmanned aircraft, referred to a drones, provide an ever expanding number of implementations. In additional to recreational use and bird's-eye view monitoring and surveillance, drones have been considered for use in package delivery, providing unique sight-seeing experiences, as well as various public safety applications.

Given all these possibilities, several limitations that still exist. For example, drones have limited range, so to use a drone in a remote area, the user would first have to transport the drone to the vicinity of interest. Additionally, unrestricted use of drones can result in violation of people's privacy (i.e. drones looking through people's windows).

### SUMMARY

A computer-implemented method according to one disclosed non-limiting embodiment of the present disclosure includes receiving a request for a drone at a specified location from a user via a computer implemented application; routing the request to a Sky Hub in proximity to the specified location; dispatching a drone along a flight path from the Sky Hub to the specified location; sending a notification to the user indicating that the drone has arrived at the specified location and that self-fly mode can be activated; proving the control of the drone for a duration of a deployment; ending the deployment by relinquishing control of the drone from the user to the Sky Hub; rerouting the drone along the flight path to return the drone to the Sky Hub.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 illustrates an exemplary Sky Hub deployment in accordance with aspects of the disclosure.

FIG. 2 provides a system diagram of an exemplary embodiment in accordance with aspects of the disclosure.

FIG. 3 illustrates a computer system adapted according to certain embodiments of the server and/or the user interface device.

FIG. 4A is a block diagram illustrating a server hosting an emulated software environment for virtualization according to one embodiment of the disclosure.

FIG. 4B is a block diagram illustrating a server hosting an emulated hardware environment according to one embodiment of the disclosure.

FIG. 5 provides a flowchart of a computer-implemented method in accordance with aspects of the disclosure.

### DETAILED DESCRIPTION

Embodiments disclosed herein are directed toward a drone dispatch system that provides individuals and/or organizations instant access to one or more drones at any remote location without requiring physical proximity. For example, a user in a remote location such as Tahiti would be able to control a drone on location at a construction project in New York City. Some embodiments may include a computer implemented application that provides access to a drone storage and recharge location called a “Sky Hub”. In some embodiments, a network of drones may be interconnected and in communication among themselves in order to avoid in flight collisions.

The “Sky Hub”, as discussed herein, refers to a drone storage and battery recharging location that facilitates communication between the user-facing computer implemented application and the infrastructure management software system. Multiple Sky Hubs may be located in different geographic locations or may be collocated or in overlapping ranges if a larger volume of drones are required in a region. When a request for a drone at a specified location is sent out, that request is routed to the Sky Hub nearest the specified location that has available drones. Sky Hubs may be linked together to coordinate drone deployments and prevent the possibility of collision.

In some embodiments, Sky Hubs may be equipped with solar panels and onboard battery storage. “Sky Hubs” may have automatic sliding doors that remain locked until a drone is cleared for takeoff. In some embodiments, a “Sky Hub” may be implemented as a mobile station that can be transported to a temporary remote locations where a permanent stationary “Sky Hub” is not desired or practical.

The user-facing computer implemented application, also referred to herein as “Sky High app”, provides connectivity between a user and a drone by sending requests and self-fly control commands via the Sky Hub system. The Sky High app may be accessible by the user on a variety of devices, including but not limited to smart phones, tablets, laptops, desktop computers, and the like.

In some embodiments, the infrastructure management software system (IMSS) may include fly zone infrastructure. Fly zone infrastructure may include a computerized system storing information regarding the autonomous flight paths for the drones. Autonomous flight path information may include flight elevation restrictions based on governmental restrictions, business category requirements, among other factors. For example, a user in the business category of Law Enforcement may be authorized to operate at 380′ to 400′ about the ground, whereas real estate company user's may be restricted to the 221′-240′ elevation range. The IMSS may further monitor and store all data regarding drones while in autonomous operation.

In some embodiments, autonomous flight paths may be configured and implemented according to predefined grid patterns.

Self-fly mode may include security settings affecting the flight capabilities accessible based on the licensing and business category of the user. For example, users within a real estate company business category may be enabled to request one or more drones to a home address, for example, to provide security monitoring of a walk through or interview. However, in such a case, the drone mounted camera could only be activate in self-fly mode at that property location; it would not allow video monitoring of neighboring properties. If the drone were directed out of the specified operational area, the drone may automatically return to autonomous mode and return to the specific operational area in which camera operation has been permitted.

In some embodiments, the Sky High app may provide various control inputs. Examples of such inputs may include but are not limited to: Self-control mode, Hover, Record, Picture, Focus, and Microphone, amongst others. Self-control mode may provide manual control of the drone to the user. Hover may cause the drone to hover in one location. Hover may be the default setting once a drone arrives at its specified location. Record my provide access to video recording functionality of the drone-mounted camera. Picture may cause the drone-mounted camera to capture a still image. Focus may select may enable selecting a specific area for the drone to fly around to capture views of all angles and sides to the area. Microphone may enable the user to access a loudspeaker attached to the drone to speak to people in proximity to the drone.

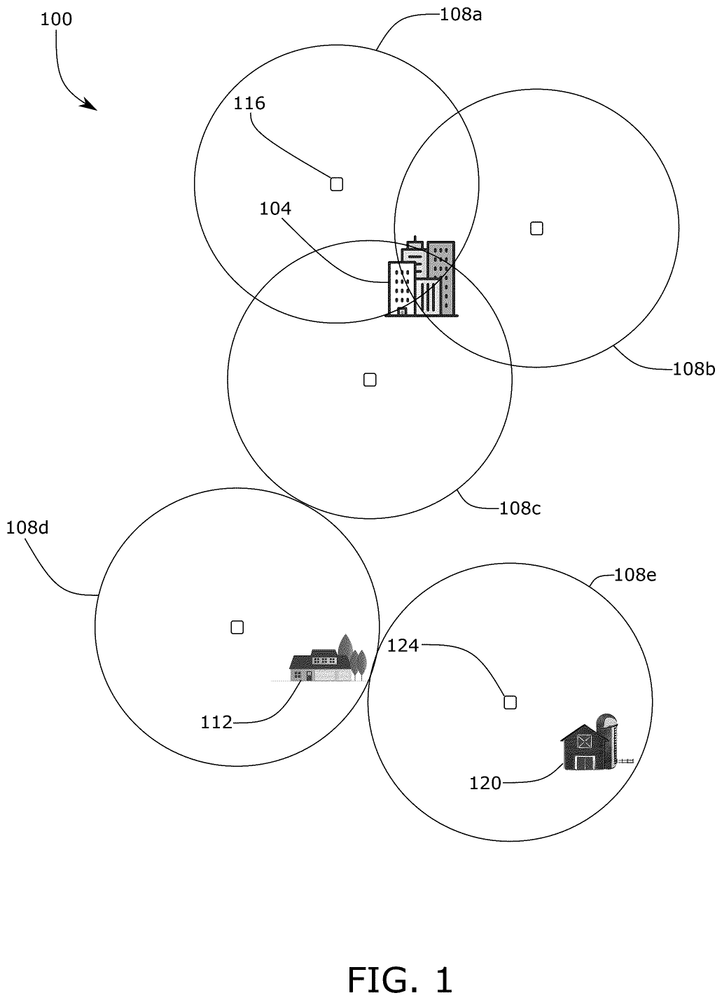

FIG. 1 illustrates an exemplary Sky Hub deployment 100 in accordance with aspects of the disclosure. As depicted, city 104 is served by multiple overlapping service zones 108 a-c to serve the larger population center. Suburb 112, in contrast, is served by a single service zone 108d. Skyhub 116 provides service to service area 108a. Rural area 120, is served by temporary service zone 108e as provided by mobile station 124.

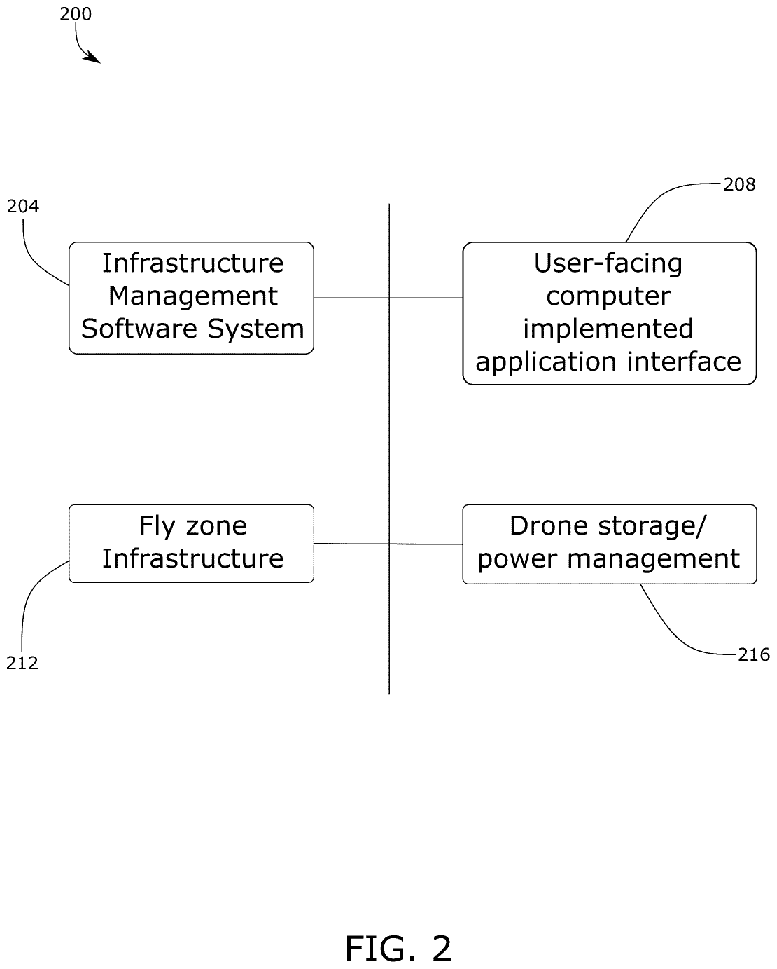

FIG. 2 provides a system diagram 200 of an exemplary embodiment in accordance with aspects of the disclosure. Infrastructure management software system (IMSS) 204 may provide a computerized system storing information regarding the autonomous flight paths for the drones. User-facing computer implemented application 208, also referred to herein as “Sky High app”, provides connectivity between a user and a drone by sending requests and self-fly control commands via the Sky Hub system. Fly zone infrastructure 212 may include a computerized system storing information regarding flight elevation restrictions based on governmental restrictions, business category requirements, among other factors. Drone storage/power management 216 may include drone storage and battery recharging within each Sky Hub which monitors the status of each drone managed by the Sky Hub and facilitates the deployment and return of such drones.

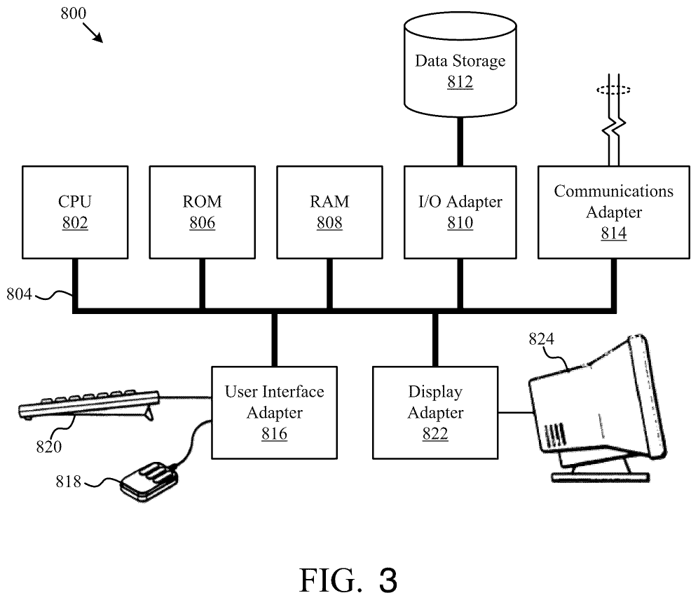

FIG. 3 illustrates a computer system 800 adapted according to certain embodiments of the server and/or the user interface device. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 also may include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The communications adapter 814 may also be adapted to couple the computer system 800 to other networks such as a global positioning system (GPS) or a Bluetooth network. The user interface adapter 816 couples user input devices, such as a keyboard 820, a pointing device 818, and/or a touch screen (not shown) to the computer system 800. The keyboard 820 may be an on-screen keyboard displayed on a touch panel. Additional devices (not shown) such as a camera, microphone, video camera, accelerometer, compass, and or gyroscope may be coupled to the user interface adapter 816. The display adapter 822 may be driven by the CPU 802 to control the display on the display device 824. Any of the devices 802-822 may be physical and/or logical.

The applications are not limited to the architecture of computer system 800. Rather, the computer system 800 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments disclosed herein are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

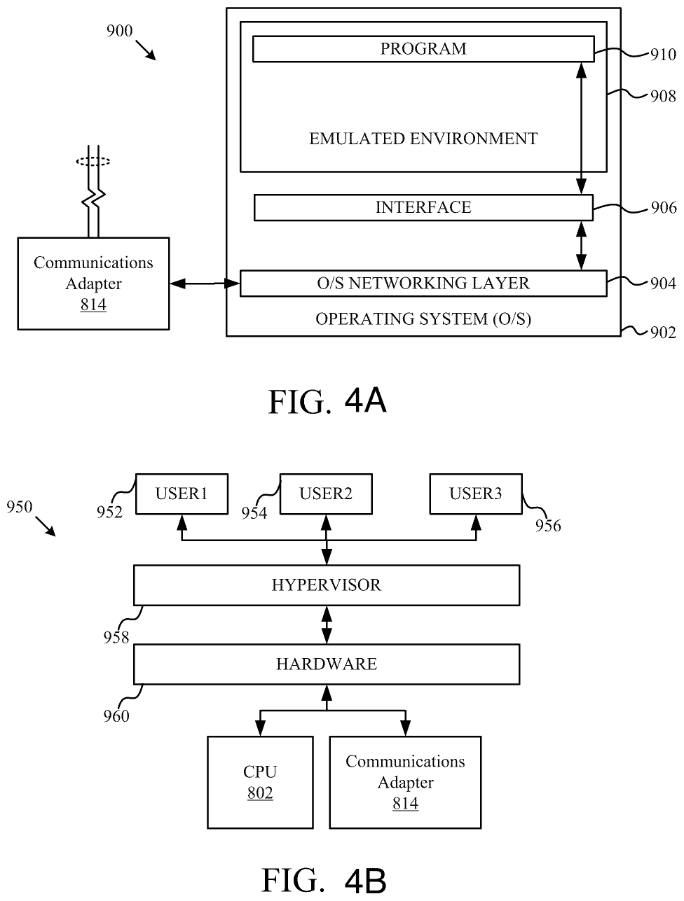

FIG. 4A is a block diagram illustrating a server hosting an emulated software environment for virtualization according to one embodiment of the disclosure. An operating system 902 executing on a server includes drivers for accessing hardware components, such as a networking layer 904 for accessing the communications adapter 814. The operating system 902 may be, for example, Linux. An emulated environment 908 in the operating system 902 executes a program 910, such as CPCommOS. The program 910 accesses the networking layer 904 of the operating system 902 through a non-emulated interface 906, such as XNIOP. The non-emulated interface 906 translates requests from the program 910 executing in the emulated environment 908 for the networking layer 904 of the operating system 902.

In another example, hardware in a computer system may be virtualized through a hypervisor. FIG. 4B is a block diagram illustrating a server hosting an emulated hardware environment according to one embodiment of the disclosure. Users 952, 954, 956 may access the hardware 960 through a hypervisor 958. The hypervisor 958 may be integrated with the hardware 960 to provide virtualization of the hardware 960 without an operating system, such as in the configuration illustrated in FIG. 4A. The hypervisor 958 may provide access to the hardware 960, including the CPU 802 and the communications adaptor 814.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

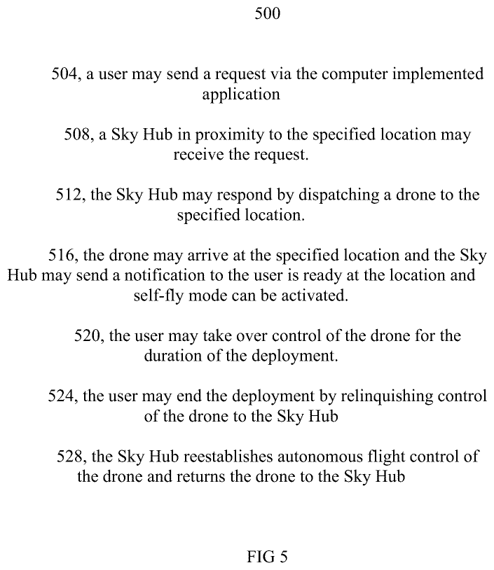

FIG. 5 provides a flowchart 500 of a computer-implemented method. At step 504, a user may send a request via the computer implemented application (i.e. Sky High app) for a drone at a specified location.

At step 508, a Sky Hub in proximity to the specified location may receive the request.

At step 512, the Sky Hub may respond by dispatching a drone to the specified location. In some embodiments, the drone may follow an autonomous flight path to the specified location using GPS navigation without reliance on drone mounted cameras or self-fly mode to prevent visual intrusion on locations between the Sky Hub and destination.

At step 516, the drone may arrive at the specified location and the Sky Hub may send a notification to the user is ready at the location and self-fly mode can be activated.

At step 520, the user may take over control of the drone for the duration of the deployment.

At step 524, the user may end the deployment by relinquishing control of the drone to the Sky Hub.

At step 528, the Sky Hub reestablishes autonomous flight control of the drone and returns the drone to the Sky Hub.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A computer-implemented method, comprising:
receiving a request for a drone at a specified location from a user via a computer implemented application;
routing the request to a Sky Hub in proximity to the specified location;
dispatching a drone along a flight path from the Sky Hub to the specified location;
send a notification to the user indicating that the drone has arrived at the specified location and that self-fly mode can be activated;
proving the control of the drone for a duration of a deployment;
ending the deployment by relinquishing control of the drone from the user to the Sky Hub; and
rerouting the drone along the flight path to return the drone to the Sky Hub.

2. The computer-implemented method of claim 1, wherein the flight path is an autonomous flight path to the specified location using GPS navigation without reliance on drone mounted cameras.

3. The computer-implemented method of claim 1, wherein the flight path is an autonomous flight path to the specified location using GPS navigation without reliance on a self-fly mode.

4. A Sky Hub deployment system, comprising:
a multiple of drones at a Sky Hub;
a computer implemented application in communication with the Sky Hub, the application operable to receive a request for a drone from the sky hub at a specified location from a user; and
an infrastructure management software system (IMSS) in communication with the computer implemented application that stores information regarding an autonomous flight path for each of the multiple of drones.
